(19) United States
(12) Patent Application Publication
(10) Pub. No.: US 2025/0371908 A1
(43) Pub. Date: Dec. 4, 2025

(54) METHOD AND DEVICE FOR DETECTING FRAUDULENT IDENTIFICATION OF A PERSON

(71) Applicant: IDEMIA PUBLIC SECURITY FRANCE, Courbevoie (FR)

(72) Inventor: Jean BEAUDET, Courbevoie (FR)

(73) Assignee: IDEMIA PUBLIC SECURITY FRANCE, Courbevoie (FR)

(21) Appl. No.: 19/199,580

(22) Filed: May 6, 2025

(30) Foreign Application Priority Data
May 30, 2024 (FR) FR2405643

(51) Int. Cl. G06V 40/40

(52) U.S. Cl. CPC G06V 40/40

(57) ABSTRACT

The method (60) for detecting fraudulent identification of a person by recognizing visible biometric features comprises:
a step (61) of controlling a value of the amplification gain of the signal leaving an image sensor (46),
a step (64) of measuring acquisition noise of at least one image of at least one part of the body of this person, said image being captured while implementing said amplification gain,
a step (70) of checking consistency, by way of comparison, between the measured noise and the determined noise, and
in the event of a lack of consistency, a step (71) of outputting a signal representative of this lack of consistency.

### FIELD OF THE INVENTION

The present invention relates to a method and a device for detecting fraudulent identification of a person. It applies in particular to the identification of a remote natural person in order to give them access to a Web resource by checking the consistency of data associated with a video stream.

### PRIOR ART

A person is generally identified on the basis of what they know, for example a password, of what they possess, for example a key, or of who they are, for example by checking a biometric datum such as a fingerprint, their voice or their face.

In the case of an identification, in particular remote identification, of a natural person, for example in order to give them access to personal data or accounts, each type of identification may be subject to attempted fraud.

Remote facial recognition, carried out using a camera of a cell phone or of a computer and by transmitting the video stream, is one promising way of identifying a person, since it allows dynamic interaction between the recipient of the video stream and the person to be identified.

Document FR201259962, published under number FR2997211, describes a method for authenticating an image capture of a face that comprises analyzing a series of images of the face at different image recording angles and determining geometric consistency between images of the series of images. This method has the drawback that the user is obliged to carry out a relative movement of the image sensor and the user's face, which requires manipulations. In addition, because the user's environment may comprise reflective areas or areas that cause glare, the user's face may be marred by an automatic sensitivity change of the sensor, or even sensor glare artefacts or artefacts of double reflection in the lens of the sensor.

Document U.S. Pat. No. 9,049,379 describes an identification method in which the focal length of the lens of the image sensor is controlled so as to analyze the effect of this change in the focusing distance on the captured image. This method has the drawback of requiring the lens to have a motorized focal length, which is not generally the case with front cameras of cell phones or computers.

One type of fraudulent identification consists in storing a video stream obtained during an identification of the person accessing a website and then in retransmitting this video stream during a new attempt to access this site.

Another type of fraudulent identification consists in using a virtual camera that produces a video stream through image synthesis based on real images of the victim of the fraud.

These two types of fraud apply both to a video stream representative of the face of the person to be identified and to another biometric data image, for example a fingerprint, a network of blood vessels (venous recognition), or an image of the palm of the hand (texture recognition) or of the shape thereof (biometric morphology), for example.

Known methods do not provide good protection against the most advanced forms of these two types of attempted fraud.

### SUMMARY OF THE INVENTION

The present invention aims to overcome all or some of the drawbacks of the prior art.

To this end, according to a first aspect, the present invention targets a method for detecting fraudulent identification of a person by recognizing visible biometric features, said method comprising:
a step of controlling a value of the amplification gain of the signal leaving an image sensor,
a step of measuring acquisition noise of at least one image of at least one part of the body of this person captured while implementing said amplification gain,
a step of checking consistency between the measured noise and the controlled gain value, and
in the event of a lack of consistency, a step of outputting a signal representative of this lack of consistency.

These provisions make it possible to detect attempted fraud consisting in employing a virtual camera that produces a video stream through image synthesis based on real images of the victim of the fraud. Specifically, image synthesis generally does not include noise corresponding to the gain applied to obtain the video stream.

Thus, at least one image capture parameter value is controlled and it is checked that the measured noise is consistent with this value. Fraud consisting in replaying a video sequence obtained during a previous identification of a victim of the attempted fraud is thus detected.

In some embodiments, during the step of controlling an amplification gain value, an exposure time of the image sensor is controlled.

The step of controlling an amplification gain value is thus implemented by way of exposure time setpoint servo-control. Specifically, controlling the exposure time causes the gain applied to the signal leaving the image sensor to vary, indirectly because of the automatic servo-control of the levels of the image and, possibly, with a delay that is able to be measured and contribute to detecting fraud.

In some embodiments, during the control step, the value of the amplification gain of the signal leaving the image sensor and the value of the exposure time of the image sensor are varied simultaneously in opposing ways.

Thus, for the person to be identified, the variations in brightness of the image compensate at least partially for one another, an increase in gain being compensated for by a reduction in exposure time, and vice versa.

In some embodiments, the method according to the invention furthermore comprises:
a step of determining metadata representative of capture conditions of at least one image on which the noise measurement is carried out, said metadata being received with data representative of this image,
a step of determining acquisition noise during the image capture, corresponding to the determined metadata, or metadata corresponding to the measured noise, and
during the consistency checking step, the measured noise and the determined noise or the metadata corresponding to the measured noise and the determined metadata are compared.

Specifically, the gain value corresponding to the images (or, equivalently, the ISO sensitivity) may be obtained in various ways, either by receiving the gain servo-control setpoint (in particular the gain command), or by reading metadata received with the data representative of this image (for example in a metadata file), or by querying a software interface (for example API of the camera). This mode of implementation thus takes into account metadata associated with the video stream.

In some embodiments, during the consistency checking step, the measured noise and the determined noise are compared over a sequence of images following a variation in the value of the amplification gain of the signal leaving the image sensor.

It is thus possible to measure the noise either on a single image or by comparing successive images, in order to get rid of noise corresponding to the manufacturing tolerance on the response of the various photosites, or pixels, of the image sensor.

One of the most lightweight implementations is:
a step of acquiring a value of the amplification gain of the signal leaving the image sensor,
a step of measuring acquisition noise of at least one image of at least one part of the body of this person captured while implementing said amplification gain,
a step of controlling another value of the amplification gain of the signal leaving the image sensor,
a step of measuring acquisition noise of at least one image of at least one part of the body of this person captured while implementing said other amplification gain,
a step of checking consistency between the measured noise values and the gain values corresponding to said at least one image.

This lightweight implementation makes it possible to apply two gain values while controlling only one, and to obtain two noise measurements.

In some embodiments, during the consistency checking step, the consistency of the adjustment time of the value of the amplification gain of the signal leaving the image sensor after a command has finished being output is checked.

It is thus possible to measure the effects of the transmitted command on a return to the image capture parameter values when the command stops being transmitted. Specifically, by design, a camera comprising the image sensor follows an algorithm for jointly optimizing the image capture parameters, in particular in order to reduce noise in the signal representative of an image, which carries out this optimization progressively on a plurality of successively captured images.

In some embodiments, the method according to the invention comprises a plurality of steps of controlling various values of the amplification gain of the signal leaving an image sensor, and a plurality of steps of measuring acquisition noise of images captured while implementing said amplification gains, and, during the consistency checking step, it is checked that the measured noise evolves in conjunction with the gain values.

It is thus the relative variations in noise and gain that are employed to check the consistency between the received images and the gain commands applied to these images. This avoids having to know the model of the image sensor and electronic control circuit (together forming a camera) to check consistency.

Advantageously, during the consistency checking step, a variation in the amplification gain within a determined time window covering all or some of the plurality of steps of controlling various amplification gain values is evaluated, and then a variation in measured noise within said time window is determined and it is checked that the variations in gain and noise are of the same sign.

As an advantageous variant, during the consistency checking step, a vector of amplification gain values within a determined time window covering all or some of the plurality of steps of controlling various amplification gain values is evaluated, and then a vector of measured noise values within said time window is determined and it is checked that the vector of measured noise values is correlated with the vector of amplification gain values.

In some embodiments, during the consistency checking step, a slope of a linear function approximating the relationship between gain and signal-to-noise ratio is evaluated and it is then determined whether this slope is within a predetermined interval of values.

Specifically, this slope is substantially constant between the various cameras with which user terminals, such as smartphones, webcams and computers, are equipped.

In some embodiments, the fraud detection method furthermore comprises:
a step of measuring motion blur in at least one image of at least one part of the body of this person, said image being captured while implementing said exposure time of the image sensor,
a step of determining motion blur during the image capture, corresponding to the exposure time command,
a step of checking consistency, by way of comparison, between the measured motion blur and the determined motion blur, and
in the event of a lack of consistency, a step of outputting a signal representative of this inconsistency.

These provisions make it possible to detect at least one instance of attempted fraud consisting in employing a virtual camera that produces a video stream through image synthesis based on real images of the victim of the fraud. Specifically, image synthesis generally does not include motion blur corresponding to the metadata associated with the video stream.

According to a second aspect, the present invention targets a device for detecting fraudulent identification of a person by recognizing visible biometric features, said device comprising:
an image sensor,
a means for controlling a value of the amplification gain of the signal leaving the image sensor,
a means for acquiring the gain value applied for each captured image,
a means for measuring acquisition noise of at least two images of at least one part of the body of this person captured while implementing at least two different amplification gains,
a means for checking consistency between the acquired gain values corresponding to said images and the measured noise values, and
a means for outputting a fraudulent identification alert, configured, in the event of a lack of consistency, to output a signal representative of this lack of consistency.

Since the particular advantages, aims and features of this device are similar to those of the method according to the invention, they will not be recalled here.

### BRIEF DESCRIPTION OF THE FIGURES

Other advantages, aims and features of the present invention will become apparent from the following description, which is given for explanatory purposes and is in no way limiting, with reference to the appended drawings, in which:

FIG. 1 shows a first particular embodiment of a device according to the present invention,

FIG. 2 shows, in the form of a flowchart, steps of the first particular embodiment of the method according to the invention,

FIG. 3 shows curves of variation in gain and noise measurement on a face, on a sequence of images,

FIG. 4 shows a second particular embodiment of a device according to the invention,

FIG. 5 shows two charts of correspondence between ISO sensitivity and signal-to-noise ratio, and

FIG. 6 shows, in the form of a flowchart, steps of a second particular embodiment of the method according to the invention.

### DESCRIPTION OF EMBODIMENTS

It should be noted that, henceforth, the figures are not to scale.

### First Embodiment of the Device According to the Invention

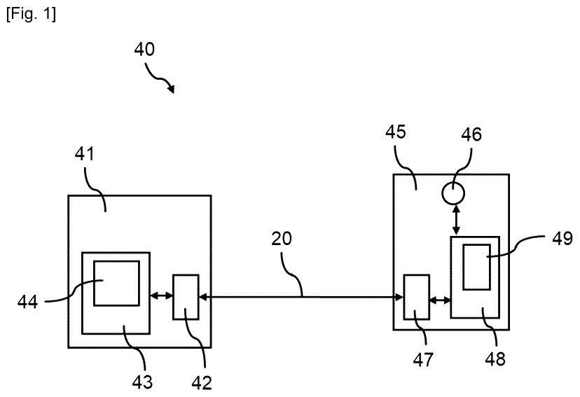

FIG. 1 shows a device 40 according to the invention, comprising an identification server 41. This server 41 is equipped with a means 42 for receiving images and for outputting image capture parameter value commands. The server 41 also comprises a memory 43 that stores received image data, received metadata, measured noise values and identification software 44 implementing the first embodiment of the method according to the invention. The server 41 is of a type that is known in computer networks.

Metadata are an important part of any file representative of images, including videos. Some types of metadata provide information about the image recording. For example, EXIF (Exchangeable Image File Format) data are a type of metadata that provide information about the image recording. More specifically, EXIF data provide information about the camera settings used to capture the video, such as lens aperture, shutter speed (or exposure time) and ISO sensitivity. Metadata of a video are generally found in the file properties or in a separate file.

The device 40 also comprises a user terminal 45 equipped with an image sensor 46 and means 47 for remotely transmitting images and for receiving image capture parameter value commands for the image sensor 46. The user terminal 45 also comprises a memory 48 that stores software 49 for controlling the operation of the image sensor 46 and of the means 47. The user terminal 45 is for example a computer or a telephone, in particular a smartphone. The parameter values preferably comprise the exposure time of the image sensor 46 and/or the amplification gain of the signal leaving the image sensor 46. For example, the software 49 is browser software, videoconferencing software or a computer application.

A network 20 transmits data between the means 47 for transmitting images and receiving commands and the means 42 for receiving images and outputting commands.

### First Embodiment of the Method According to the Invention

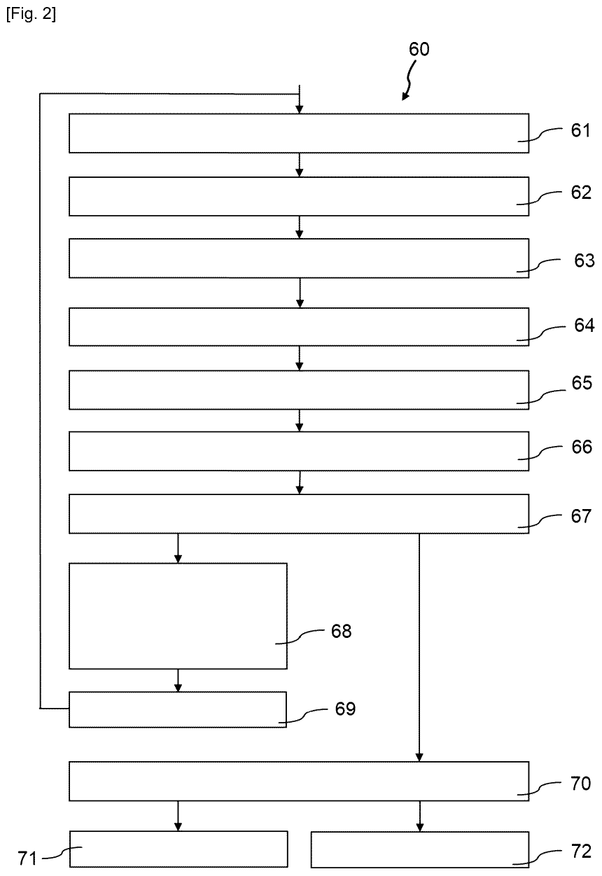

In conjunction with the user terminal 45, the software 44 implements the method 60 illustrated in FIG. 2. This method 60 detects fraudulent identification of a person, this identification being carried out by recognizing visible biometric features, in particular a face, a fingerprint, a network of blood vessels or an image of the palm of the hand or of the shape thereof.

In this method 60, a challenge-response mechanism is implemented, each challenge being a gain command (corresponding to an ISO sensitivity) and the response being a measurement of noise in the received images. In the preferred embodiment illustrated in FIG. 2, the “challenge” is a random sequence of gain level commands, preferably a piecewise-constant function, that is to say a function that is constant in successive increments. The “response” is obtained by estimating the SNR (signal-to-noise ratio).

One particularly lightweight implementation of this mechanism, said implementation having the advantage of not requiring knowledge about the image sensor or the camera that is employed, consists of:
a step of acquiring a value of the amplification gain of the signal leaving the image sensor,
a step of measuring acquisition noise of at least one image of at least one part of the body of this person captured while implementing said amplification gain,
a step of controlling another value of the amplification gain of the signal leaving the image sensor,
a step of measuring acquisition noise of at least one image of at least one part of the body of this person captured while implementing said other amplification gain,
a step of checking consistency between the measured noise values and the gain values corresponding to said at least one image.

This implementation makes it possible to apply two gain values while controlling only one, and to obtain two noise measurements. The consistency check may be limited to checking that the variations in gain and noise are of the same sign, or may be more complex, as described below.

In FIG. 2, this method 60 comprises a step 61 of controlling a gain applied to the signal leaving the image sensor 46. As a variant, the exposure time of the image sensor 46 is controlled because an automatic gain controller of the camera then adjusts the gain applied to the signal leaving the image sensor depending on the average level of this signal, which is itself influenced by the exposure time during the capture of an image.

Preferably, as illustrated in FIGS. 1 and 2, the camera is controlled remotely, by changing the value of the ISO sensitivity, by directly controlling the amplification gain, or the exposure time of the image sensor 46 is controlled.

It should be noted here that the utilities for configuring brightness, contrast, white balance, etc. of a video stream are known, for example the FFmpeg® utility. Similarly, Windows 11® makes it possible to control image brightness, contrast, saturation and/or sharpness. Finally, the “properties” of a camera may be edited on many operating systems.

Preferably, the changes in gain are made as discreetly as possible for the person to be identified (the user of the terminal 45), while ensuring that they are compensated for by changes in exposure time. Thus, preferably, during the control step 61, the value of the amplification gain of the signal leaving the image sensor and the value of the exposure time of the image sensor are varied simultaneously in opposing ways. There are several possible ways of doing this:
explicitly: if the gain is multiplied by α, the exposure time is divided by α,
through servo-control: automatic exposure time control is activated, or
indirectly: automatic gain control is activated, and it is exposure time that is varied instead of gain.

The changes/servo-control operations might not be immediate. This may be taken into account by computing a time lag between the challenge and the response. For example, using a ZNCC or by using a priori information regarding the response time of the image sensor and its associated electronics.

It is also possible to take into account an uncertainty on the response time, and to ignore noise estimates for a duration “response_time_max” after each transition. The changes may also be made more discreet by normalizing the average brightness of the image before it is (optionally) displayed to the person to be identified.

The method 60 then comprises a step 62 of capturing at least one image of at least one part of the body of the person to be identified, using the image sensor 46, while implementing each parameter value controlled by the software 44.

During a step 63, the user terminal 45 transmits at least one captured image to the server 41, via the means 47 for transmitting images and the means 42 for receiving images.

During a step 64, the software 44 measures and stores acquisition noise of at least one received image. The noise level is measured either based on a single image, using a known method, or based on multiple successive images (by comparing them with one another, pixel by pixel, using a known method). For noise estimation in a single image, the reader may refer to the publication Chen, G., Zhu, F., & Ann Heng, P. (2015). “An efficient statistical method for image noise level estimation”. In Proceedings of the IEEE International Conference on Computer Vision (pp. 477-485). For noise estimation on multiple successively captured images, it is possible to first carry out spatial registration and then measure the difference in signal value for each photosite of the image sensor in the registered image area. It is thus possible to compute noise through a standard deviation estimation.

It is possible to acquire the gain corresponding to the images (or, equivalently, the ISO sensitivity) either using an output gain command or by querying a software interface (API for application programming interface) of a camera, or by reading it from a file of metadata associated with the image, as in step 65 described below. During this optional step 65, the software 44 determines metadata representative of capture conditions of at least one image on which the noise measurement is carried out. These metadata represent an exposure time of the image sensor 46 and/or an amplification gain of the signal leaving the image sensor 46. In a first variant, metadata are received with the data representative of at least one image. In a second variant, metadata are determined on the basis of the command transmitted during control step 61, that is to say of the parameter values transmitted to the user terminal 45 during step 61.

During an optional step 66, the software 44 determines and stores acquisition noise during the image capture, which corresponds to the determined metadata, as described below. If the metadatum determined during step 65 comprises ISO sensitivity (corresponding to the gain), and preferably the image sensor 46 and/or camera model implemented by the user terminal 45, the typical noise level corresponding to the sensitivity value is determined during step 66. It should be noted that, depending on the camera manufacturer, the gain applied to the signal leaving the image sensor may vary. As a variant, during step 66, metadata that may correspond to the measured noise are determined.

During a step 67, the software 44 determines whether a predetermined number of gain value variation commands has been reached. For example, this number is five iterations. If this number has not been reached, the software 44 determines, preferably randomly or pseudorandomly, a new gain value and, possibly, a waiting time, during a step 68. Once this waiting time has elapsed, during a step 69, the software 44 returns the gain value to step 61, which is reiterated along with steps 62 to 67.

The sequence of successions of steps 61 to 67 typically lasts a few seconds, for example ten seconds. If the challenge is in increments, an increment typically lasts two to three seconds. The duration of an increment itself may be random, as explained with reference to step 68.

If the result of step 67 is positive, during a step 70, the software 44 checks the consistency between the measured and stored noise, on the one hand, and the gain commands applied to the image sensor 46, on the other hand.

Advantageously, during this consistency checking step 70, a variation in the amplification gain within a determined time window covering all or some of the plurality of steps 61 of controlling various amplification gain values is evaluated, and then a variation in measured noise within said time window is determined and it is checked that the variations in gain and noise are of the same sign.

As an advantageous variant, during the consistency checking step 70, a vector of amplification gain values within a determined time window covering all or some of the plurality of steps 61 of controlling various amplification gain values is evaluated, and then a vector of measured noise values within said time window is determined and it is checked that the vector of measured noise values is positively correlated with the vector of amplification gain values.

### Consistency Check between Noise Measurements and Gain Commands

A first method consists, if optional steps 65 and 66 have been carried out, in that the consistency check is carried out between the measured and stored noise, on the one hand, and the received and stored metadata, on the other hand. To this end, a comparison is carried out between the measured noise values and noise values corresponding to the received metadata, or a comparison is carried out between metadata corresponding to the measured noise and received metadata. If more than one iteration of steps 61 to 67 has been carried out, preferably, during consistency checking step 70, a comparison is carried out between the measured noise and the determined noise over a sequence of images following a variation in the value of the amplification gain of the signal leaving the image sensor and/or the value of the exposure time of the image sensor.

The signal-to-noise ratio (SNR) is a measured value. The metadata of interest are a gain value corresponding to an ISO (International Organization for Standardization) sensitivity and/or an exposure time value. To check the consistency between these values, it is possible to use various algorithms:
based on the measurement of the signal-to-noise ratio, the gain (or ISO sensitivity) and/or the exposure time are/is estimated; these estimated metadata and the known metadata are then compared (based on the operating commands of the sensor or the metadata associated with the analyzed image stream);
based on the known metadata, the expected signal-to-noise ratio is estimated, and then the measured signal-to-noise ratio and the expected signal-to-noise ratio are compared;

The conversion between what is received or measured and what is estimated or expected is typically based on charts that depend on the camera model implemented by the user terminal. One example of such charts 77 and 78 is shown in FIG. 5. In this example, the measured ISO sensitivity is shown on the abscissa and the signal-to-noise ratio is on the ordinate.

In a second method, rather than searching for a chart corresponding to the image sensor, use is made of the comparison of the variation in the measured signal-to-noise ratio and the variation in the controlled ISO sensitivity. For example, it is checked that the signal-to-noise ratio evolves in the opposite direction to ISO sensitivity: when the ISO level is varied significantly, for example by multiplying it by two, a significant decrease in the signal-to-noise ratio should be observed (that is to say an increase in noise with the gain applied to the signal leaving the sensor). It is therefore possible to apply a plurality of ISO sensitivity values over the same number of time intervals, measure the average signal-to-noise ratio over each interval, and check that each change in ISO sensitivity value exhibits a corresponding variation in the signal-to-noise ratio in the opposite direction.

In one preferred variant, the expected relationship between the signal-to-noise ratio and the ISO sensitivity is checked. Indeed, this relationship is generally of the type snr_dB=a*log (ISO)+b,

in which formula “snr_dB” is signal-to-noise ratio in decibels, “ISO” is ISO sensitivity, “b” is a constant and a is a multiplicative constant, or slope, approximately equal to −10. It is possible for example to perform a linear regression to obtain the values of the constants a and b, and consider that the consistency is correct if the value of the slope a is closer to −10 than to 0. More generally, it is determined whether this slope a is within a predetermined interval of values. For example, this interval ranges from minus infinity to −5 or between −20 and −5.

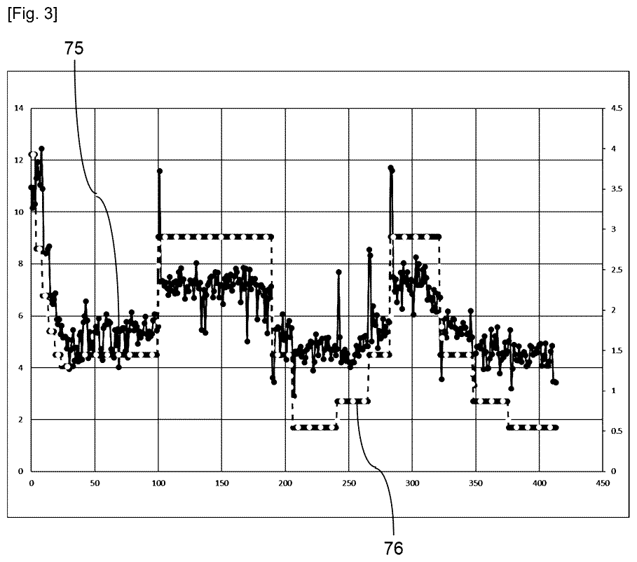

As shown in FIG. 3, the relationship between gain and noise is not entirely linear. In FIG. 3, the curve 75 shows a succession of measured noises and the curve 76 shows the gain values. In some variants, this non-linearity is taken into account for example by applying, to the challenge, a matching function that is typical for a camera (or pre-calibrated) before checking consistency with the received response.

Typically, the interval of the variations in gain (or exposure time) of the challenge is determined by carrying out the start of the sequence in automatic mode, and by recording the exposure time and the gain after convergence (typically, one second).

As an alternative to measuring the slope of the function linking signal-to-noise ratio (in decibels) to ISO sensitivity, the number of consistent transitions between the challenge and the response is counted:
the amplification gain of the signal leaving the image sensor evolves incrementally in increasing or decreasing fashion,
for each time interval corresponding to one increment, the average of the SNR is computed,
for each transition, it is noted that this average is constant (that is to say varies, with respect to the previous increment, by less than a predetermined value, for example 10%), increasing, or decreasing (constant: variation<threshold_transition)
the number or proportion of transitions the evolution of which does not correspond to the evolution of the amplification gain is counted, and
if this number or proportion is greater than a predetermined limit value, it is concluded that attempted fraud is present.

As a variant or in addition, during step 70, the consistency of the adjustment time of the value of the amplification gain of the signal leaving the image sensor and/or of the value of the exposure time of the image sensor after a command has finished being output is checked.

In the event of a lack of consistency, during a step 71, the software 44 outputs a signal representative of this lack of consistency in order to block the continuation of the process of identifying the person and thus prohibit them from being identified.

In the event of consistency being confirmed, during a step 72, the software 44 authorizes the continuation of the process of identifying the person using identification software based on matching of visible biometric features. This identification software is of a known type.

### Second Embodiment of the Device According to the Invention

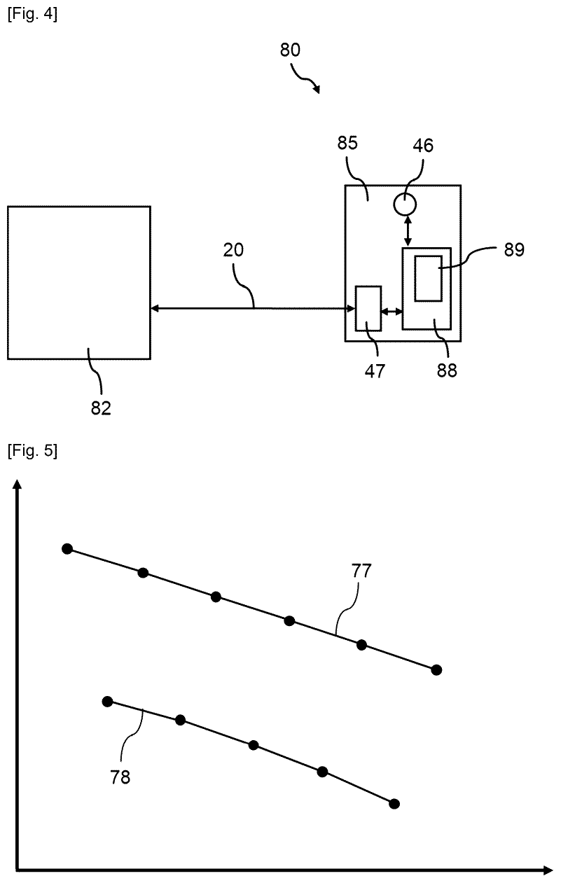

In the second embodiment of the device according to the invention, the technical means are integrated into the user terminal. FIG. 4 shows a device 80 according to the invention comprising a user terminal 85 equipped with an image sensor 46 and a means 47 for remotely transmitting messages and for receiving operating commands.

The user terminal 85 also comprises a memory 88 that stores software 89 for controlling the operation of the image sensor 46 and of the transmission means 47.

For example, the software 89 controls the operation of browser software, videoconferencing software or a computer application. The memory 88 also stores captured image data, metadata of the captured images and measured noise values.

A network 20 transmits data between the means 47 for transmitting images and for receiving commands and a means 82 for identifying a user by recognizing biometric features, of a known type.

In the method 60 illustrated in FIG. 2, the software 89 performs the steps of the software 44. This method 60 thus detects fraudulent identification of a person directly in the user terminal 85. The message output by the software 89 during either of steps 71 and 72 is transmitted by the transmission means 47 to the identification means 82, in order to authorize or not authorize the continuation of the process of identifying the person using the terminal 85.

As will be understood from reading the above description, each of the devices 40 or 80 for detecting fraudulent identification of a person by recognizing visible biometric features comprises:
an image sensor 46,
a means, 42 or 89, for controlling a value of the amplification gain of the signal leaving the image sensor,
a means for acquiring the gain value applied for each captured image,
a means, 43 and 44, or 89, for measuring acquisition noise of at least two images of at least one part of the body of this person, said images being captured while implementing at least two different amplification gains,
a means, 43 and 44, or 89, for checking consistency between the acquired gain values corresponding to said images and the measured noise values, and
a means, 43, 44 and 47, or 89, for outputting a fraudulent identification alert, configured, in the event of a lack of consistency, to output a signal representative of this lack of consistency.

Additional technical information is given below for at least one embodiment of the device and method according to the invention.

### Second Embodiment of the Method According to the Invention

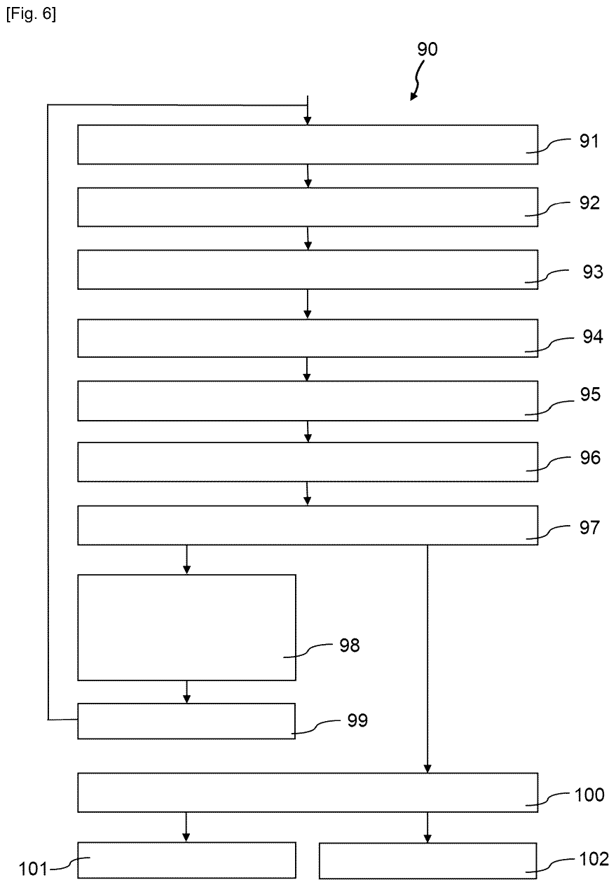

In the second embodiment of the method according to the invention, the consistency between a measured motion blur and the exposure time of the image sensor during at least one image capture is checked. The devices 40 and 80 illustrated in FIGS. 1 and 4 enable this method to be implemented. In conjunction with the user terminal 45 or 85, the software, 44 or 89, implements the method 90 illustrated in FIG. 6. This method 90 supplements the method 60 or replaces it. This method 90 detects fraudulent identification of a person, this identification being carried out by recognizing visible biometric features, in particular a face, a fingerprint, a network of blood vessels or an image of the palm of the hand or of the shape thereof.

This method 90 comprises a step 91 of controlling an image capture parameter of the image sensor 46. For example, this parameter comprises the exposure time of the image sensor 46 and/or an amplification gain of the signal leaving the image sensor 46.

The method 90 then comprises a step 92 of capturing at least one image of at least one part of the body of the person to be identified, using the image sensor 46, while implementing each parameter value controlled by the software 44 or 89.

During a step 93, the user terminal 45 transmits at least one captured image to the server 41, via the means 47 for transmitting images and the means 42 for receiving images. In the case of the user terminal 85, the captured image is analyzed directly by the software 89, without remote image transmission.

During a step 94, the software 44 or 89 measures and stores motion blur during the acquisition of at least one received image.

During a step 95, the software 44 or 89 determines metadata representative of capture conditions of at least one image on which the motion blur measurement is carried out. These metadata represent an exposure time of the image sensor 46. In a first variant, metadata are received with the data representative of at least one image. In a second variant, metadata are the parameter values transmitted to the user terminal during step 91.

During a step 96, the software 44 or 89 determines and stores motion blur during the acquisition during the image capture, which corresponds to the determined metadata.

As a variant, during step 96, metadata that may correspond to the measured motion blur are determined.

During a step 97, the software 44 or 89 determines whether a predetermined number of image capture parameter value variations for the image sensor 46 has been reached. For example, this number is ten iterations. If this number has not been reached, the software 44 or 89 determines, preferably randomly or pseudorandomly, a new parameter value and, possibly, a waiting time, during a step 98. Once this waiting time has elapsed, during a step 99, the software 44 or 89 returns the parameter value to step 91, which is reiterated along with steps 92 to 97.

If the result of step 97 is positive, during a step 100, the software 44 or 89 checks the consistency between the measured and stored motion blur and the received and stored metadata, by comparing the measured motion blur values and motion blur values corresponding to the received metadata or by comparing metadata corresponding to the measured motion blur and received metadata.

In the event of a lack of consistency, during a step 101, the software 44 or 89 outputs a signal representative of this lack of consistency in order to block the continuation of the process of identifying the person.

In the event of consistency being confirmed, during a step 102, the software 44 or 89 authorizes the continuation of the procedure of identifying the person.

Generally speaking, measuring motion blur requires a long exposure time and relatively fast movements of the person to be identified.

It should be noted here that the consistency of the motion blur may be determined by comparing speeds of movement (in pixels/second), that is to say by comparing the motion blur divided by the exposure time and the distance between the position of the region of interest between two images divided by the time interval between said two images, a deviation greater than a predetermined threshold characterizing a lack of consistency.

Equivalently, it is possible to directly compare the motion blurs, that is to say the estimated motion blur corresponding to the distance between respective positions in two images (tracking) multiplied by the exposure time and divided by the time interval between said two images and the measured motion blur, obtained in particular according to one of the methods cited in the article by Tiwari, S., Shukla, V. P., Singh, A. K., & Biradar, S. R. (2013). Review of motion blur estimation techniques. Journal of Image and Graphics, 1(4), 176-184, this measurement being able to be performed in a single image. The consistency check is carried out by checking for a match between the motion blur estimated by tracking and the measured motion blur, a deviation greater than a predetermined threshold characterizing a lack of consistency.

In this embodiment, the user may be encouraged to move by being given an instruction to move.

1. A method for detecting fraudulent identification of a person by recognizing visible biometric features, the method comprising:
controlling a value of an amplification gain of a signal leaving an image sensor,
measuring acquisition noise of at least one image of at least one part of a body of the person captured while implementing said amplification gain,
checking consistency between the measured noise and the controlled value of the amplification gain, and
in an event of a lack of consistency, outputting a signal representative of the lack of consistency.

2. The method for detecting fraud as claimed in claim 1, wherein, the step of controlling the value of the amplification gain, further comprises controlling a value of an exposure time of the image sensor.

3. The method for detecting fraud as claimed in claim 2, wherein the controlling step further comprises varying the value of the amplification gain of the signal leaving the image sensor and the value of the exposure time of the image sensor simultaneously in opposing ways.

4. The method for detecting fraud as claimed in claim 1, furthermore further comprising:
determining metadata representative of capture conditions of at least one image on which the noise measurement is performed, said metadata being received with data representative of the at least one image,
determining acquisition noise during the image capture, corresponding to the determined metadata, or metadata corresponding to the measured noise, and
during the consistency checking step , comparing the measured noise and the determined noise or the metadata corresponding to the measured noise and the determined metadata.

5. The method for detecting fraud as claimed in claim 1, wherein the consistency checking step further comprises comparing the measured noise and the determined noise over a sequence of images following a variation in the value of the amplification gain of the signal leaving the image sensor.

6. The method as claimed in claim 5, wherein the consistency checking step further comprises checking the consistency of the adjustment time of the value of the amplification gain of the signal leaving the image sensor after a command has finished being output.

7. The method for detecting fraud as claimed in claim 1, further comprising a plurality of steps of controlling various values of the amplification gain of the signal leaving an image sensor, and a plurality of steps of measuring acquisition noise of images captured while implementing said amplification gains, and, during the consistency checking step checking that the measured noise evolves in conjunction with the gain values.

8. The method for detecting fraud as claimed in claim 7, wherein the consistency checking step further comprises evaluating a slope of a linear function approximating a relationship between the gain and a signal-to-noise ratio and determining whether the slope is within a predetermined interval of values.

9. The method for detecting fraud as claimed in claim 7, wherein the consistency checking step further comprises evaluating a variation in the amplification gain within a determined time window covering all or some of the plurality of steps of controlling various amplification gain values, determining a variation in measured noise within said time window, and checking that the variations in gain and noise are of a same sign.

10. The method for detecting fraud as claimed in claim 7, wherein the consistency checking step further comprises evaluating a vector of amplification gain values within a determined time window covering all or some of the plurality of steps of controlling various amplification gain values, determining a vector of measured noise values within said time window, and checking that the vector of measured noise values is correlated with the vector of amplification gain values.

11. The method for detecting fraud as claimed in on claim 2, further comprising:
measuring motion blur in at least one image of at least one part of the body of the person, said image being captured while implementing said exposure time of the image sensor,
determining motion blur during the image capture, corresponding to an exposure time command,
checking consistency, by way of comparison, between the measured motion blur and the determined motion blur, and
in the event of a lack of consistency, a step of outputting a signal representative of the inconsistency.

12. A device for detecting fraudulent identification of a person by recognizing visible biometric features, the device comprising:
an image sensor,
means for controlling a value of the amplification gain of a signal leaving the image sensor,
means for acquiring the value of the amplification gain applied for each captured image,
means for measuring acquisition noise of at least two images of at least one part of the body of the person, said images being captured while implementing at least two different amplification gains,
means for checking consistency between the acquired gain values corresponding to said images and the measured noise values, and
means for outputting a fraudulent identification alert, configured, in an event of a lack of consistency, to output a signal representative of the lack of consistency.
